(19) United States
(12) Patent Application Publication
(10) Pub. No.: US 2025/0077827 A1
(43) Pub. Date: Mar. 6, 2025

(54) SYSTEMS AND METHODS FOR REMOTELY MONITORING DEVICE HEALTH

(71) Applicant: Temptime Corporation, Morris Plains, NJ (US)

(72) Inventors: Bradley WILLARD, Suwanee, GA (US); Eric LIBERATO, Pequannock, NJ (US); Mohannad ABDO, Clifton, NJ (US); Ashley COUSIN, Chatham, NJ (US); Evan KELLY, Oak Park, IL (US)

(73) Assignee: Temptime Corporation, Morris Plains, NJ (US)

(21) Appl. No.: 18/240,122

(22) Filed: Aug. 30, 2023

(51) Int. Cl. G06K 19/077

(52) U.S. Cl. CPC G06K 19/07758; G06K 19/07773

(57) ABSTRACT

Systems and methods of remotely monitoring a device are provided. An example includes a system comprising a deformable element configured to be in contact with a monitored device. An electrical property of the deformable element changes in response to at least one of deformation of the deformable element or exposure of the deformable element to an ionic material. The system further includes a communication module operatively coupled to the deformable element, the communication module having a logic circuit and an antenna. The logic circuit may be configured to determine a change in the electrical property of the deformable element, wherein, in response to receiving a signal from a transceiver, the communication module is configured to report the change in the electrical property via the antenna to a controller communicatively coupled to the transceiver.

### BACKGROUND

Devices, such as batteries, may experience physical change as a result of a malfunction of the device. For example, if a battery is improperly stored, overcharged, experiencing high temperatures, or damaged, it may experience swelling, resulting in a physical change to the shape of the battery, or leakage, resulting in material being leaked from the battery. Both of these issues are a detriment to the health of the battery (as well as the health of the device in which the battery is installed) and can pose safety issues (e.g., the batteries can explode or cause a fire). Accordingly, a system and method for remotely monitoring and detecting conditions such as these in order to monitor the health of the battery or device.

### SUMMARY

Systems and methods for detecting device health are provided. In an embodiment, the present invention is a system for remotely monitoring a device comprising a deformable element configured to be in contact with a monitored device, the deformable element having an electrical property which changes in response to at least one of deformation of the deformable element or exposure of the deformable element to a material, such as an ionic material. The system includes a communication module operatively coupled to the deformable element, the communication module having a logic circuit and an antenna. The logic circuit may be configured to determine a change in the electrical property of the deformable element, wherein, in response to receiving a signal from a transceiver, the communication module is configured to report the change in the electrical property via the antenna to a controller communicatively coupled to the transceiver.

In a variation of this embodiment, the monitored device is a battery and the deformable element is affixed to a surface of the battery.

In another variation of this embodiment, the communication module comprises an RFID tag, the deformable element is a deformable capacitive element operatively coupled to the RFID tag, and the transceiver comprises an RFID reader.

In another variation of this embodiment, the logic circuit is configured to determine at least one of a change in a physical size of the battery or discharge of battery fluid from the battery.

In another variation of this embodiment, the RFID tag and the deformable element are formed on a substrate. The substrate includes a main portion upon which the RFID tag is formed and a flap portion upon which the deformable element is formed. The flap portion may be folded relative to the main portion to position the flap portion and the main portion in a stacked configuration. The main portion may be affixed to the monitored device and the flap portion is disposed between the main portion and the monitored device. The main portion retains the flap portion against the monitored device.

In another variation of this embodiment, the RFID tag is formed on a first substrate and the deformable element is formed on a second substrate. The RFID tag is electrically coupled to the deformable element by vias formed on the first substrate and the second substrate. The first and second substrates may be disposed in a stacked configuration. The first substrate may be affixed to the monitored device with the second substrate disposed between the first substrate and the monitored device. The first substrate retains the second substrate against the monitored device.

In another variation of this embodiment, the system may further comprise an absorptive material overlaying the deformable element. The absorptive is configured to absorb the material (e.g., ionic material) discharged from the monitored device.

In a variation of this embodiment, the absorptive material includes a first end that is spaced away from the deformable element and a second that overlays the deformable element, wherein the absorptive material transports the material (e.g., ionic material) from the first end to the second end.

In a variation of this embodiment, the communication module further includes a temperature sensor configured to determine a temperature of the monitored device, and, in response to receiving a signal from a transceiver, the communication module is further configured to report the temperature of the monitored device determined by the temperature sensor via the antenna to the controller communicatively coupled to the transceiver.

In another embodiment, the present disclosure includes a method of remotely monitoring a device comprising monitoring, via a logic circuit of a communication module, an electrical property of a deformable element in contact with a monitored device. The electrical property changes in response to at least one of deformation of the deformable element or exposure of the deformable element to a material, such as an ionic material. The method may further comprise determining, via the logic circuit, a change in the electrical property has occurred, and, in response to the communication module receiving a signal from a transceiver, transmitting the change in the electrical property from the communication module to a controller communicatively coupled to the transceiver.

In a variation of this embodiment, the method further comprises determining a temperature of the monitored device via a temperature sensor of the communication module, and, in response to receiving a signal from a transceiver, transmitting the temperature to a controller communicatively coupled to the transceiver.

In another variation of this embodiment, the monitored device is a battery.

In another variation of this embodiment, the sensor is configured to determine at least one of a change in a physical size of the battery or discharge of battery fluid from the battery.

In another variation of this embodiment, determining a change in the electrical property includes detecting whether an absorptive material overlaying the deformable element has absorbed the material (e.g., ionic material) discharged from the monitored device or has transported the material from a first end to a second end. The first end is spaced away from the deformable element and the second end overlays the deformable element.

In another embodiment, the present disclosure includes a system for remote monitoring of a fleet of devices comprising a plurality of a monitoring modules. Each monitoring module is configured to be associated with a monitored device of a fleet of monitored devices. Each monitoring module includes a deformable element and a communication module. The deformable element is in contact with the monitored device and an electrical property of the deformable element changes in response to at least one of deformation of the deformable element or exposure of the deformable element to a material, such as an ionic material. The communication module is operatively coupled to a deformable element and has a logic circuit and an antenna. The logic circuit of the communication module is configured to determine whether the electrical property of the deformable element has changed. The system may further comprise a transceiver that is configured to transmit a request signal to the communication module of each of the plurality of monitoring modules. In response to the request signal, the communication module of at least one of the plurality of monitored modules is configured to report whether the electrical property has changed via the antenna to a controller communicatively coupled to the transceiver, wherein the controller is remote from the transceiver.

In a variation of this embodiment, the transceiver is configured to periodically transmit the request signal over an area having at least one monitored device, in response to at least one of a user input or a control signal from the controller.

In a variation of this embodiment, the system further comprises a second transceiver.

In another variation of this embodiment, each monitored device is a battery and each deformable element is affixed to a surface of one of the monitored devices.

In another variation of this embodiment, the logic circuit is configured to determine at least one of a change in a physical size of the battery or discharge of battery fluid from the battery.

In another embodiment, the present disclosure includes a method of remotely monitoring a fleet of devices comprising monitoring a fleet of devices via a plurality of monitoring modules, each of the plurality of monitoring modules being associated with a different one of the devices in the fleet of devices. Each monitoring module has a deformable element and communication module, the deformable element being in contact with a corresponding one of the devices in the fleet of devices, and an electrical property of the deformable element is configured to change in response to at least one of deformation of the deformable element or exposure of the deformable element to a material, such as an ionic material. The communication module is operatively coupled to the deformable element and has a logic circuit and an antenna. The method further comprises transmitting a request signal via at least one transceiver to at least one of the communication modules, and, in response to receiving a request signal from the at least one transceiver, determining, via the logic circuit, a change in the electrical property of the deformable element of at least one of the plurality of monitoring modules has occurred. The method further comprises transmitting the change in the electrical property from the communication module associated with the at least one of the plurality of monitoring modules to a controller communicatively coupled to the transceiver, wherein the controller is remote from the transceiver.

In a variation on this embodiment, transmitting a request signal via at least one transceiver includes periodically transmitting the request signal over an area having at least one monitored device of the fleet.

In another variation on this embodiment, transmitting a request signal includes periodically transmitting multiple request signals via multiple transceivers over an area having at least one monitored device of the fleet.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example system of the present disclosure.

FIGS. 2A-B illustrate additional example systems of the present disclosure.

FIGS. 3A-B illustrate an additional example system of the present disclosure in use over time.

FIGS. 4A-C illustrate additional example systems of the present disclosure.

FIG. 5 is a flowchart illustrating an example method of the present disclosure.

FIG. 6 illustrates an example system of the present disclosure implemented as a battery monitoring system at a battery storage facility.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Mechanisms utilizing radio frequency transmission are often used for the detection of a change in a physical condition of a device. However, systems implementing such technology have been limited in their coverage area and conditions monitored. Therefore, a system and method that allows for improved device health sensing would be beneficial.

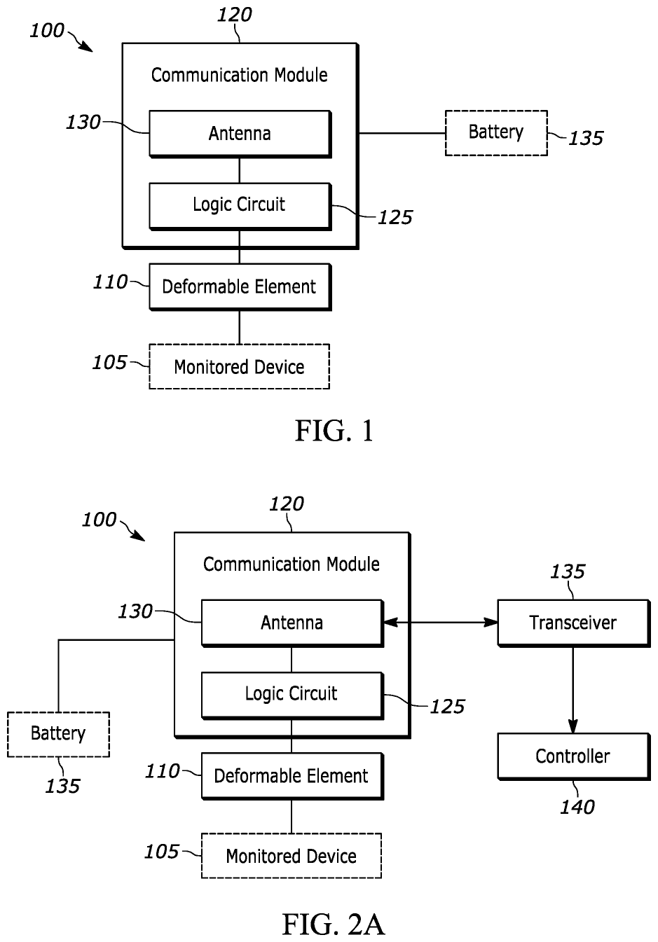

FIG. 1 illustrates an example system 100 of the present disclosure. The system 100 may include a deformable element 110 configured to be in contact with a monitored device 105. The monitored device 105 may be, for example, a battery, a pipe, a hydraulic device, a pneumatic device, a motor, an engine, a pump, a can or bottle, or any other device that may swell and/or leak a material, such as an ionic material. The deformable element 110 has an electrical property which changes in response to at least one of a deformation of the deformable element 110 or exposure of the deformable element 110 to a material (e.g., an ionic material).

The system 100 may also include a communication module 120 operatively connected to the deformable element 110 having an antenna 130 and a logic circuit 125 configured to determine a change in the electrical property of the deformable element 110. The logic circuit can be an integrated circuit. The logic circuit 125 may also be configured to detect a change in the physical size of the monitored device 105, such as a battery. The electrical property of the deformable element 110 may vary due to presence of a deformation of the deformable element or exposure to, for example, an ionic material. For example, the deformable element 110 may undergo strain, causing a deformation of the deformable element 110, due to a change in the shape of the monitored device 105. In the event the monitored device 105 experiences swelling, the deformable element 110 may experience strain such that a deformation forms in the deformable element, which changes the electrical property of the deformable element 110, for example the electrical resistance or capacitance of the deformable element. The logic circuit 125 may be configured to detect this change and in response output a signal to the antenna 130. As one example, the logic circuit 125 can include a strain or capacitance sensor. The system may include a battery 135 to power the communication module 120 or the system may utilize inductive coupling such that the system is powered by energy extracted from a radiofrequency (RF) signal that are converted to electrical signals by the antenna 130.

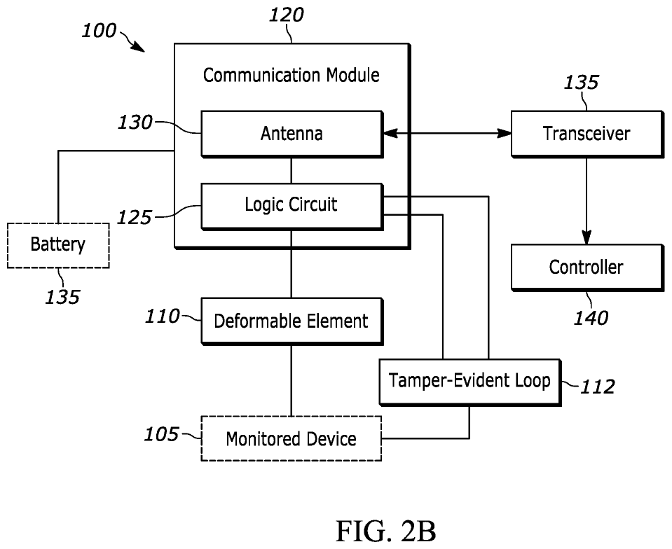

FIG. 2A illustrates another example system 100 of the present disclosure. The system may include a battery 135 to power the communication module 120 or the system may utilize inductive coupling such that the system is powered by energy extracted from a RF signal that are converted to electrical signals by the antenna 130. The system 100 may receive a RF signal from a transceiver 135, e.g. via antenna 130 of the communication module 120. In response to this signal, the communication module 120 may report a change in the electrical property of the deformable element 110 (e.g., resulting from the presence of a deformation in the deformable element 110 and/or the presence of a material (e.g., an ionic material) proximate to or in contact with the deformable element 110) via the antenna 130 to a controller 140 communicatively coupled to the transceiver 135. For example, the communication module 120 may be an RFID tag and the deformable element 110 may be a deformable capacitive or resistive element affixed to the monitored device 105 (e.g., a battery) to monitor for swelling of the monitored device 105 and/or to detect leakage of a material (e.g., an ionic material) from the monitored device 105. The communication module 120 is operatively connected to the deformable element 110, which may undergo strain as a result of the monitored device 105 swelling. The transceiver 135 may be an RFID reader configured to transmit a signal to provide RF energy to the communication module 120. In response to this signal, the logic circuit 125 of the RFID tag may determine if the deformable element 110 has been deformed, as a result of the monitored device 105 swelling and/or if a leaked material (e.g., an ionic material) is disposed proximate to or in contact with the deformable element 110, and report this change via antenna 130 to controller 140 in communication with the RFID reader. As a result of receiving this signal, the controller 140 may provide an alert indicating that the monitored battery has swelled or is leaking, and thus, may be unsafe or unfit for use. The system 100 may include a passive or active communication module 120, with active modules powered by battery 135. For example, the communication module may be a passive or an active RFID tag. Alternatively, a system 100 powered by battery 135 may be configured to perform Bluetooth beaconing, in which, in response to the logic circuit 125 detecting a change in the electrical property of the deformable element 110, the logic circuit 125 begins to periodically output a signal via the antenna 130 indicating the monitored device 105 is experiencing a change, for example swelling or leaking.

FIG. 2B illustrates the example system 100 shown in FIG. 2A except that a tamper-evident loop structure 112 is also attached to the logic circuit 125. The tamper-evident loop structure 112 can include a conductive path between two terminals of the logic circuit 125, where the conductive path can include at least one discontinuity forming an incomplete circuit between the two terminals of the logic circuit 125. The discontinuity in the conductive path can be completed by material leaking from the monitored device 105 to form a continuous circuit between the two terminals of the logic circuit 125. The change in the tamper-evident loop structure 112 from discontinuous to continuous or vice versa can be detected by the logic circuit and can be used in combination with or independently from the deformable element 110 to provide information about the monitored device 105. As an example, the logic circuit 125 can be configured to use a change in the electrical property of the deformable element 110 to determine a change in the size of the monitored device 105 has occurred (e.g., due to swelling) and can use a change in the tamper-evident loop to determine that the monitored device 105 is leaking material.

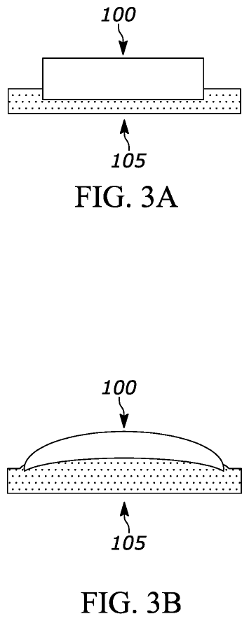

FIGS. 3a and 3b illustrate an example implementation of a system of the present disclosure. FIG. 3a shows a system 100, including the communication module 120 and the deformable element 110, affixed to a monitored device 105, for example a battery. As shown in FIG. 3b, the monitored device 105 may undergo swelling resulting in a change of its physical shape. This swelling may also result in a change of shape of the deformable element 110, which may be detected by the logic circuit 125 of the communication module 120 and transmit a signal indicating such swelling via antenna 130. In this example, the monitored device 105 of FIG. 3a may be a battery that has deformed to the state shown in FIG. 3b while the battery was installed in a barcode scanner. In another example, the monitored device 105 of FIG. 3a may be a battery that may have deformed to the state shown in FIG. 3b while the battery was in storage (e.g., in a desk drawer, back room, warehouse, distribution center) or in a charging device.

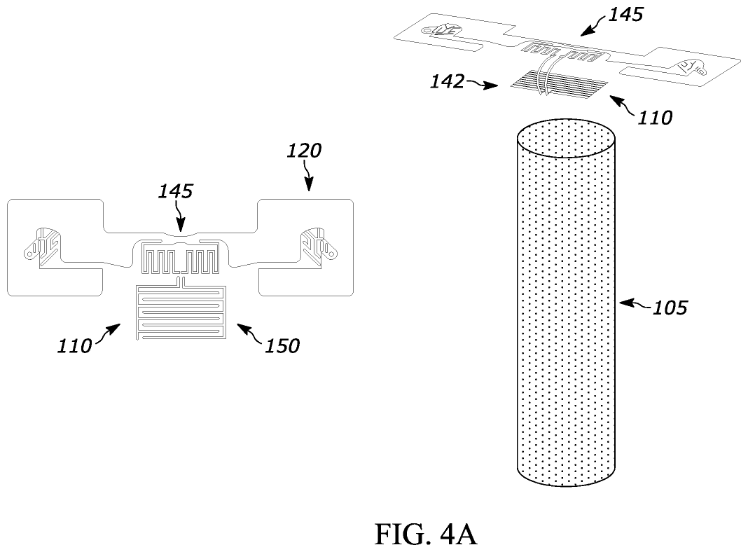

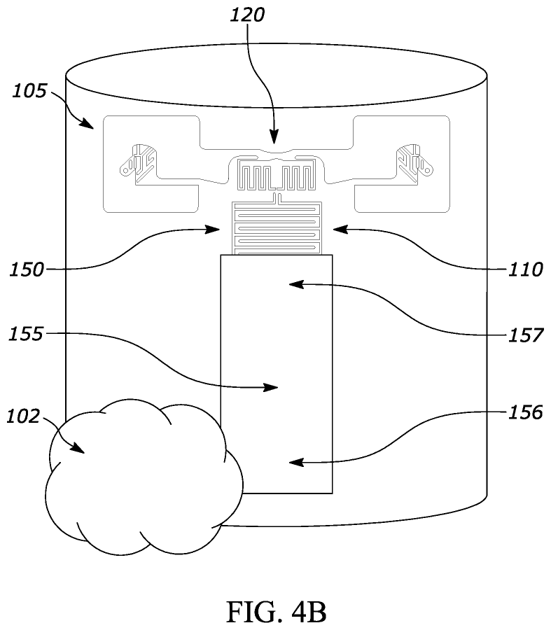

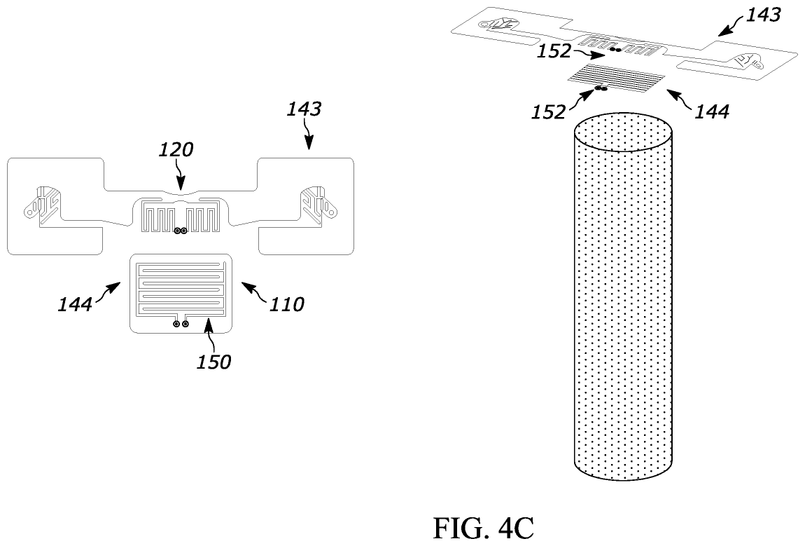

FIG. 4A illustrates another example system of the present disclosure. The system may further include the deformable element 110 that has a deformable capacitive structure 150 in contact with a monitored device 105 (e.g., a battery). For example, the system 100 may include a communication module 120 in the form of an RFID tag positioned on the monitored device 105 to monitor for swelling and/or leakage. The monitored device 105 may, for example, leak a conductive material, which is absorbed by deformable capacitive structure 150, changing its capacitance. The logic circuit 125 may be configured to detect this change and report it via antenna 130, in response to receiving a signal from an RFID tag reader. As shown in FIG. 4A, the communication module 120, being an RFID tag, and the deformable element 110, being a deformable capacitive structure 150, may be formed together on a substrate which includes a main portion 145 upon which the RFID tag is formed and a flap portion 142 upon which the deformable element is formed. The flap portion 142 is folded relative to the main portion 145 to position the flap portion 142 and the main portion 145 in a stacked configuration, e.g., in order to avoid the communication module 120 being damaged by coming into contact with leaked battery fluid and/or to apply moderate pressure on the deformable element 110 to hold the deformable element against the monitored device 105. The main portion 145 may be affixed to the monitored device 105, and the flap portion 142 may be disposed between the main portion 145 and the monitored device 105, the main portion 145 retaining the flap portion 142 against the monitored device 105.

FIG. 4B illustrates another example system of the present disclosure. The system may include a communication module 120 in the form of an RFID tag. The system may include a deformable capacitive structure 150 in communication with the communication module 120 that may be covered with an absorptive material 155 configured to absorb the material 102 (e.g., ionic material) discharged from the monitored device 105. The absorptive material 155 may also include a first end 156 that is spaced away from the deformable element 110 and/or the deformable capacitive structure 150. The absorptive material 155 may also include a second end 157 that overlays, at least in part, the deformable element 110. The absorptive material 155 may transport the material 102 leaked out of the monitored device 105 from the first end 156 to the second end 157. That absorptive material 155 may also be, for example, filter paper configured to soak up the material 102. As a result of absorbing the material, the capacitance of the deformable capacitance structure 150 may change. The logic circuit 125 may be configured to detect this change and report it via antenna 130, in response to receiving a signal from a transceiver, for example, an RFID tag reader.

FIG. 4C illustrates another example system of the present disclosure. The system may include a communication module 120 in the form of an RFID tag. The RFID tag may be formed on a first substrate 143, and the deformable element 110, a deformable capacitive structure 150, for example, may be formed on a second substrate 144. The RFID tag is electrically connected to the deformable element 110, and this connection may be formed by vias 152 formed on the first substrate 143 and the second substrate 144.

In another example system of the present disclosure, the communication module 120 may also include a temperature sensor configured to determine a temperature of the monitored device 105. For example, the temperature sensor can be included in the logic circuit 125. In response to receiving a signal from a transceiver 135, the communication module 120 is further configured to report the temperature of the monitored device 105 determined by the temperature sensor via the antenna 130 to the controller 140 communicatively coupled to the transceiver 135. For example, the system 100 may be affixed to an engine. The communication module may include the temperature sensor which detects the temperature of the engine, and in response to receiving a signal from a transceiver 135, the communication module 120 is further configured to report the temperature of the monitored device 105 determined by the temperature sensor via the antenna 130 to the controller 140 communicatively coupled to the transceiver 135. In another example, the temperature sensor is affixed to a battery, or another monitored electronic device.

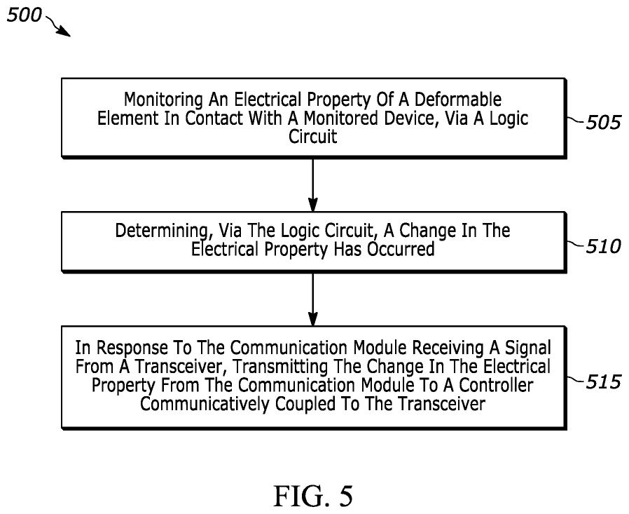

FIG. 5 is a block flowchart illustrating a method of the present invention. Although the example method 500 is described with reference to the flowchart illustrated in FIG. 5, it will be appreciated that many other methods of performing the acts associated with the method 500 may be used. For example, the order of some of the blocks may be changed, certain blocks may be combined with other blocks, blocks may be repeated, and some of the blocks described are optional. The method 500 may be performed by processing logic that may comprise hardware (circuitry, dedicated logic, etc.), software, or a combination of both.

Method 500 includes monitoring an electrical property of the deformable element 110 in contact with the monitored device 105, via the logic circuit 125, the electrical property changes in response to at least one of deformation of the deformable element 110 or exposure of the deformable element 110 to a material (e.g., an ionic material) leaked from the monitored device 105 (block 505). For example, the communication module 120 may include an RFID tag operatively connected to a deformable element 110 having an electrical property (e.g., capacitance or resistance) that changes when a material (e.g., an ionic material) leaks out from a monitored device 105 onto the deformable element 110 and/or the deformable element is deformed (e.g., due a swell or a change in sized of the monitored device 105). In this way the communication module 120 may monitor a monitored device 105 (e.g., a battery) for leakage and/or swelling with the deformable element 110.

Example method 500 further includes determining via the logic circuit 125 that a change in the electrical property of the deformable element 110 has occurred (block 510). For example, the logic circuit 125 may be configured to detect the a change in capacitance or resistance of the deformable element 110 that results from the monitored device 105 leaking fluid (e.g., ionic fluid) onto a deformable element and/or from a deformation of the deformable element 110 due to swelling of the monitored device 105.

The example method 500 also include, in response to the communication module 120 receiving a signal from a transceiver 135, transmitting the change in the electrical property from the communication module 120 to the controller 140 communicatively coupled to the transceiver 135 (block 515). For example, an RFID tag reader may transmit a signal to the communication module 120, and in response, the logic circuit 125 may determine whether there has been a change in the electrical property has occurred and may report the change to a server in communication with the reader.

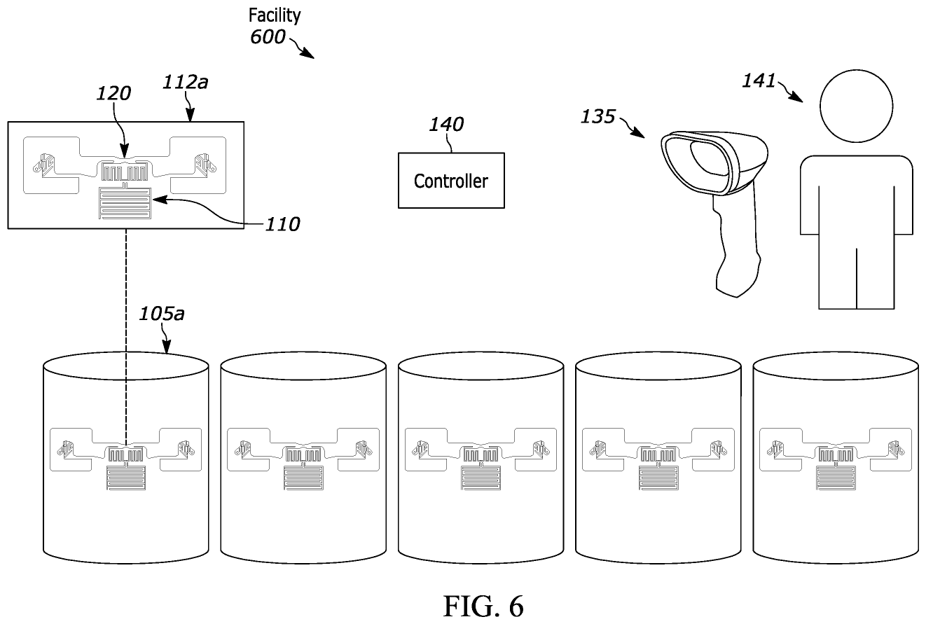

FIG. 6 illustrates another example system of the present disclosure. The system may include a plurality of a monitoring modules, e.g. monitoring module 112a, each monitoring module 112a configured to be associated with a monitored device, e.g. monitored device 105a, of a fleet of monitored devices. Each monitoring module may include a deformable element 110 in contact with the monitored device 105 and a communication module 120. An electrical property of the deformable element 110 may change in response to at least one of deformation of the deformable element 110 or exposure of the deformable element 110 to a leaked material (e.g., an ionic material). The communication module 120 of each monitoring module, e.g. 112a, is operatively coupled to the deformable element 110 and has the logic circuit 125 and the antenna 130. The logic circuit 125 of the communication module may be configured to determine whether the electrical property of the deformable element 110 has changed.

For example, a facility 600 may house a fleet of monitored devices, such as a fleet of batteries, each having a monitoring module affixed thereto. The monitoring module, e.g. 112a, may include a communication module 120 in the form of an RFID tag connected to a deformable element 110 such as a deformable capacitive structure. In the event of leakage, the battery may swell and/or may leak material (e.g., ionic material) onto the deformable capacitive structure, changing the capacitance of the structure. The logic circuit 125 of the RFID tag may be configured to detect this change and in response, output a signal.

The system may further include a transceiver 135, configured to transmit a request signal to the communication module 120 of each of the monitoring modules. In response to the request signal, the communication module 120 of at least one of the plurality of monitoring modules, e.g. 112a, is configured to report whether the electrical property has changed via the antenna 130 to a controller 140 communicatively coupled to the transceiver 135, wherein the controller 140 is remote from the transceiver 135. The controller 140 may be remote from the transceiver 135.

For example, a user 141 with the transceiver 135, for example an RFID tag reader, may read each RFID tag affixed to each battery in a battery storage facility 600. Alternatively, or in addition, the facility 600 can include fixed RFID readers that can periodically poll (e.g., transmit an RF signals) the monitoring modules to determine whether that has been a change in the electrical property of any of the deformable elements in the monitoring modules. In response to receiving a signal from the RFID tag reader, the logic circuit 125 of an RFID tag may determine if there has been a change in the capacitance of the deformable capacitive structure 110 indicative of a leak from a monitored battery and/or swelling from the monitored battery. The logic circuit 125 may transmit a signal via the antenna 130 of the communication module 120 indicating this change and the existence of a possible leak or swelling (e.g., size change) to the controller 140 communicatively coupled to transceiver 135. The user 141 may access data via the controller 140 storing the content of the signal such that the user can determine the status of a particular battery from a particular read signal from the reader. The response from the monitoring modules can also be used to determine a location of the monitoring modules for which there has been a change in the electrical property of their respective deformable elements.

The transceiver 135 may be configured to periodically transmit the request signal over an area having at least one monitored device, in response to at least one of a user input or a control signal from the controller. The system may further include a second transceiver configured to transmit a request signal to the communication module of each of the monitoring modules. For example, a first transceiver may be positioned to transmit a request signal to a first portion of the fleet of monitored batteries. The first transceiver may periodically transmit the request signal to the communication module of each of the plurality of monitoring modules. In response to receiving the request signal, the logic circuit 125 of each monitoring module may detect if there has been a change in the deformable element affixed to the battery, for example due to swelling of the battery and/or leakage from the battery, and transmit a signal indicating this change to a controller 140 communicatively coupled to the first transceiver. A user 141 with a second handheld transceiver, e.g. transceiver 135, may use the transceiver to send a request signal to each monitoring module that indicated a change in size, in order to transmit another request signal to confirm swelling and/or leakage of the monitored device. In this way the present disclosure provides methods and systems that allow for improved monitoring and detection of device health, for example by detecting swelling or leakage.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A system for remotely monitoring a device, the system comprising:
a deformable element configured to be in contact with a monitored device, an electrical property of the deformable element changes in response to at least one of deformation of the deformable element or exposure of the deformable element to an ionic material; and
a communication module operatively coupled to the deformable element, the communication module having a logic circuit and an antenna, the logic circuit configured to determine a change in the electrical property of the deformable element, wherein, in response to receiving a signal from a transceiver, the communication module is configured to report the change in the electrical property via the antenna to a controller communicatively coupled to the transceiver.

2. The system of claim 1, wherein the monitored device is a battery and the deformable element is affixed to a surface of the battery.

3. The system of claim 2, wherein the logic circuit is configured to determine at least one of a change in a physical size of the battery or discharge of battery fluid from the battery.

4. The system of claim 1, wherein the area defined by the plurality of interleaved discontinuous paths has a perimeter with a circular, oval, or rectangular shape.

5. The system of claim 3, wherein the RFID tag and the deformable element are formed on a substrate,
the substrate includes a main portion upon which the RFID tag is formed and a flap portion upon which the deformable element is formed,
the flap portion is folded relative to the main portion to position the flap portion and the main portion in a stacked configuration,
the main portion is affixed to the monitored device and the flap portion is disposed between the main portion and the monitored device, the main portion retaining the flap portion against the monitored device.

6. The system of claim 3, wherein the RFID tag is formed on a first substrate and the deformable element is formed on a second substrate,
the RFID tag is electrically coupled to the deformable element is formed by vias formed on the first substrate and the second substrate,
the first and second substrates are disposed in a stacked configuration,
the first substrate is affixed to the monitored device with the second substrate disposed between the first substrate and the monitored device, the first substrate retaining the second substrate against the monitored device.

7. The system of claim 1, further comprising:
an absorptive material overlaying the deformable element, the absorptive configured to absorb the ionic material discharged from the monitored device.

8. The system of claim 7, wherein the absorptive material includes a first end that is spaced away from the deformable element and a second that overlays the deformable element, wherein the absorptive material transports the ionic material from the first end to the second end.

9. The system of claim 1, wherein the communication module further includes a temperature sensor configured to determine a temperature of the monitored device, and wherein, in response to receiving a signal from a transceiver, the communication module is further configured to report the temperature of the monitored device determined by the temperature sensor via the antenna to the controller communicatively coupled to the transceiver.

10. A method of remotely monitoring a device comprising:
monitoring, via a logic circuit of a communication module, an electrical property of a deformable element in contact with a monitored device, the electrical property changes in response to at least one of deformation of the deformable element or exposure of the deformable element to an ionic material;
determining, via the logic circuit, a change in the electrical property has occurred; and
in response to the communication module receiving a signal from a transceiver, transmitting the change in the electrical property from the communication module to a controller communicatively coupled to the transceiver.

11. The system of claim 10, further comprising determining a temperature of the monitored device via a temperature sensor of the communication module, and, in response to receiving a signal from a transceiver, transmitting the temperature to a controller communicatively coupled to the transceiver.

12. The system of claim 10, wherein the monitored device is a battery.

13. The system of claim 12, wherein the sensor is configured to determine at least one of a change in a physical size of the battery or discharge of battery fluid from the battery.

14. The system of claim 10, wherein determining a change in the electrical property includes detecting whether an absorptive material overlaying the deformable element, the absorptive material being configured to absorb the ionic material discharged from the monitored device, has transported the ionic material from a first end to a second end, the first end spaced away from the deformable element and the second end overlaying the deformable element.

15. A system for remotely monitoring of a fleet of devices comprising:
a plurality of a monitoring modules, each monitoring module configured to be associated with a monitored device of a fleet of monitored devices, wherein each monitoring module includes a deformable element and a communication module, the deformable element is in contact with the monitored device and an electrical property of the deformable element changes in response to at least one of deformation of the deformable element or exposure of the deformable element to an ionic material, the communication module is operatively coupled to a deformable element and has a logic circuit and an antenna, the logic circuit of the communication module is configured to determine whether the electrical property of the deformable element has changed; and
a transceiver, configured to transmit a request signal to the communication module of each of the plurality of monitoring modules, wherein, in response to the request signal, the communication module of at least one of the plurality of monitored modules is configured to report whether the electrical property has changed via the antenna to a controller communicatively coupled to the transceiver, wherein the controller is remote from the transceiver.

16. The system of claim 15, wherein the transceiver is configured to periodically transmit the request signal over an area having at least one monitored device, in response to at least one of a user input or a control signal from the controller.

17. The system of claim 15, further comprising a second transceiver.

18. The system of claim 15, wherein each monitored device is a battery and each deformable element is affixed to a surface of one of the monitored devices.

19. The system of claim 18, wherein the logic circuit is configured to determine at least one of a change in a physical size of the battery or discharge of battery fluid from the battery.

20. A method of remotely monitoring a fleet of devices comprising:
monitoring a fleet of devices via a plurality of monitoring modules, each of the plurality of monitoring modules being associated with a different one of the devices in the fleet of devices, each monitoring module having a deformable element and communication module, the deformable element is in contact with a corresponding one of the devices in the fleet of devices and an electrical property of the deformable element is configured to change in response to at least one of deformation of the deformable element or exposure of the deformable element to an ionic material, the communication module is operatively coupled to the deformable element and has a logic circuit and an antenna;
transmitting a request signal via at least one transceiver to at least one of the communication modules;
in response to receiving a request signal from the at least one transceiver, determining, via the logic circuit, a change in the electrical property of the deformable element of at least one of the plurality of monitoring modules has occurred; and
transmitting the change in the electrical property from the communication module associated with the at least one of the plurality of monitoring modules to a controller communicatively coupled to the transceiver, wherein the controller is remote from the transceiver.

21. The method of claim 20, wherein transmitting a request signal via at least one transceiver includes periodically transmitting the request signal over an area having at least one monitored device of the fleet.

22. The method of claim 20, wherein transmitting a request signal includes periodically transmitting multiple request signals via multiple transceivers over an area having at least one monitored device of the fleet.
